(19) United States
(12) Patent Application Publication
(10) Pub. No.: US 2026/0368069 A1
(43) Pub. Date: Nov. 19, 2026

(54) PROGRAM RUNNING STATE INDICATION SYSTEM AND PHYSICAL CODE BLOCK

(71) Applicant: WUHAN PAIYOU TECH LTD, WUHAN (CN)

(72) Inventors: BOCHEN YE, WUHAN (CN); ZHENHAI TU, WUHAN (CN); YAN LI, WUHAN (CN); HAO SHI, WUHAN (CN); JINGSEN ZHOU, WUHAN (CN); JICHUAN ZHONG, WUHAN (CN); ZIJIE ZHENG, WUHAN (CN)

(21) Appl. No.: 19/720,931

(22) Filed: Jun. 26, 2026

Related U.S. Application Data
(63) Continuation of application No. PCT/CN2025/081981, filed on Mar. 12, 2025.

(30) Foreign Application Priority Data
Mar. 27, 2024 (CN) 202410355255.3

(51) Int. Cl. G06F 11/362; G06F 11/3698

(52) U.S. Cl. CPC G06F 11/3648; G06F 11/3698

(57) ABSTRACT

A program running state indication system and a physical code block are provided. The program running state indication system includes a plurality of program statement blocks, the program statement blocks include indicator bars, the indicator bars are configured to indicate a program running state, and each of the indicator bars includes a plurality of light-emitting units that may be independently controlled. The program running state is indicated by means of changes in light of the indicator bars, such that a user can obtain information required for program debugging intuitively and efficiently, and intuitively understand the program running process and state.

### TECHNICAL FIELD

The present disclosure relates to the field of program debugging, and in particular to a program running state indication system and a physical code block.

### BACKGROUND

For current program debugging, indication of a current state of program running is quite limited. Typically, in an integrated development environment, when a program is running, neither a current running position of the program nor a current running branch of the program is displayed, but only whether the program is running is displayed. In some integrated development environments, a line number where the program is paused is displayed when the program is paused, while in some other integrated development environments, a line of code being executed is highlighted. However, program developers do not know information such as which branch the program has executed, a logic path through which the program jumps, a way of expression calculation, an expression operator precedence, an intermediate process of expression calculation, and a result of expression calculation.

### SUMMARY

To solve the related technical problems and overcome defects in the prior art, including that a current code debugging system fails to indicate a flow relationship between specific program statements during program running, the present disclosure provides a program running state indication system and a physical code block, such that a user can obtain information required for program debugging intuitively and efficiently, and intuitively understand a program running process and state.

A technical solution adopted by the present disclosure to solve the above technical problems is to provide a program running state indication system, and the system includes a plurality of program statement blocks, where each of the program statement blocks is provided with an indicator bar including a plurality of light-emitting units, the plurality of program statement blocks are spliced to form a program running indicator board configured to represent a designated program module, and the indicator bars in the program running indicator board are mated to form a light-emitting indicator running light strip; the light-emitting indicator running light strip is configured to represent a program running state of the designated program module, when the designated program module is executed, light-emitting units of the light-emitting indicator running light strip are lit sequentially in a running direction of the designated program module, and when the designated program module runs to any program statement, the light-emitting units of the program statement block corresponding to the program statement are lit, where lighting patterns of the light-emitting indicator running light strip corresponding to different program running states are different, and the program statement blocks in the program running indicator board are in one-to-one correspondence with program statements in the designated program module;
the light-emitting indicator running light strip formed after splicing is configured to indicate a program flow control state, the indicator bar of each of the program statement blocks includes at least one entry indicator bar and at least one exit indicator bar, one end of the entry indicator bar extends to a mating end face of the program statement block, the other end of the entry indicator bar is connected to one end of the exit indicator bar, and the other end of the exit indicator bar extends to a mating end face of the program statement block;
when the program statement blocks are spliced together, the entry indicator bars and the exit indicator bars between the program statement blocks are mated with each other to form the light-emitting indicator running light strip;
at least one program statement block in the program running state indication system includes at least two exit indicator bars;
during program running, a program statement block corresponding to a previously executed program statement is referred to as a preceding program statement block, a program statement block corresponding to a currently executed program statement is referred to as a current program statement block, and a program statement block corresponding to a next program statement to be executed is referred to as a subsequent program statement block;

When the program runs to a program statement corresponding to any program statement block, the following steps are included:
the light-emitting units of the entry indicator bar of the current program statement block that is mated with the preceding program statement block are lit sequentially in a direction from the preceding program statement block to the current program statement block, while brightness of remaining entry indicator bars of the current program statement block remains unchanged;
calculation or operation of a program statement corresponding to the current program statement block is performed; and
the light-emitting units of the exit indicator bar of the current program statement block that is mated with the subsequent program statement block are lit sequentially in a direction from the current program statement block to the subsequent program statement block, while brightness of remaining exit indicator bars of the current program statement block remains unchanged.

Preferably, the program running state includes a program flow control state, and the program flow control state includes at least one of a sequential program running state, a loop state, a branch state, a jump state, a wait state, and a subroutine call state, and the light-emitting indicator running light strip is lit according to a lighting pattern corresponding to the program flow control state when the program running indicator board works.

Preferably, the program running state includes a program expression calculation state, the indicator bar includes a Boolean data indicator bar and/or a numeric data indicator bar, the Boolean data indicator bar and/or the numeric data indicator bar are respectively disposed in a designated statement block in the program statement block, and when the designated program module performs program expression calculation, the Boolean data indicator bar and/or the numeric data indicator bar are lit according to a lighting pattern corresponding to the program expression calculation state.

Preferably, one or more program statement blocks constitute one line of program statement unit, each line of program statement unit represents one line of code in the designated program module, and the program running indicator board is composed of a plurality of lines of the program statement units; and
the light-emitting indicator running light strip includes a first light-emitting light strip configured to represent the program flow control state and a second light-emitting light strip configured to represent the program expression calculation state, the first light-emitting light strip extends from the program statement unit in a first line to the program statement unit in a last line, the second light-emitting indicator running light strip is horizontally distributed along the program statement unit in a designated line, and the program statement unit in the designated line is formed by splicing a plurality of program statement blocks.

Preferably, the program statement blocks are identical and/or different in types, and the types of the program statement blocks include at least two of a flow control type, a data structure type, an input/output type, and an operator type.

Preferably, the program statement block includes a jump semantic program statement block, the jump semantic program statement block is provided with a spotlight or a projection lamp, and a lighting direction of the spotlight or the projection lamp is the same as a jump direction of the designated program module.

Preferably, the Boolean data indicator bar is lit in different colors when values of the Boolean data indicator bar calculated in the program expression calculation state are Boolean true and Boolean false; and the numeric data indicator bar is lit with a higher brightness when an absolute value of a value of the numeric data indicator bar calculated in the program expression calculation state is larger.

Preferably, the system further includes an input device, the light-emitting units on the program statement block corresponding to the input device are lit according to an input state of the input device; and when the input state of the input device varies, the light-emitting units on the program statement block corresponding to the input device are lit in different colors, brightness or patterns.

Preferably, the program statement blocks are graphic controls on the graphical user interface, and are spliced together by dragging and dropping the program statement blocks on the graphical user interface to form the program running indicator board.

Preferably, the program statement blocks are physical code blocks, the physical code blocks are provided with electronic interfaces, and the physical code blocks are connected to each other via the electronic interfaces.

The present disclosure further provides a physical code block, including a building block body, where the building block body is the program statement block in the program running state indication system.

Through the above program running state indication system or the physical code block, the user can obtain information required for program debugging intuitively and efficiently, and intuitively understand the program running process and state. By observing a lighting path of the light-emitting units on the indicator bar of the program statement block and a flow direction of light formed by sequentially lighting the light-emitting units, the user can intuitively understand a running position of the program at any moment, a branch executed, a program jump method and path, a reading result of an input device, an output state of an output device, a current value of a variable, types and values of various data, an order of expression calculation, and a result of expression calculation, thereby greatly improving the developer's program debugging efficiency and learning efficiency for program development.

### BRIEF DESCRIPTION OF THE DRAWINGS

FIG. 1 is a schematic structural diagram of a program running state indication system according to an embodiment of the present disclosure.

FIG. 2 is a schematic structural diagram of a program statement block according to an embodiment of the present disclosure.

### DETAILED DESCRIPTIONS OF THE EMBODIMENTS

The present disclosure will be further described in detail below in combination with accompanying drawings and embodiments. “A plurality of” mentioned herein means two or more.

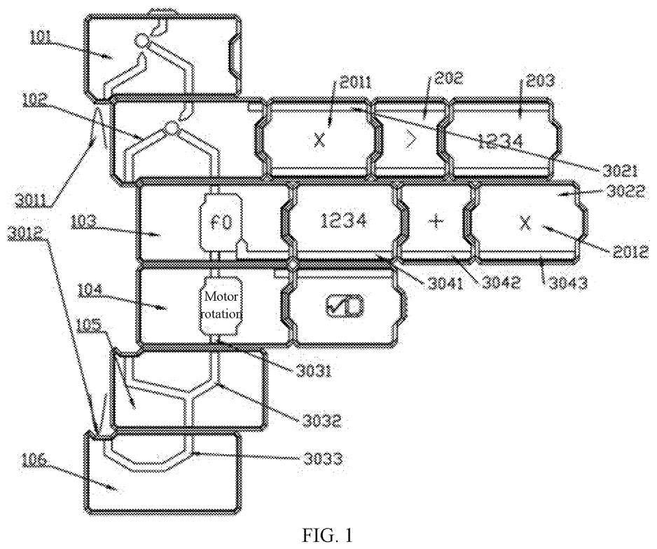

FIG. 1 illustrates a program running state indication system, and a complete program is constructed by splicing a plurality of program statement blocks. The program running state indication system may be a system formed by splicing physical program statement blocks or may be a graphical programming IDE system running on a mobile phone, computer, or tablet.

In an optional embodiment, the program running state indication system includes a plurality of program statement blocks, the program statement blocks are building blocks printed with graphics or text symbols representing program statements, and the above building blocks may be physical code blocks, such as plastic building blocks with built-in circuit boards or virtual building blocks displayed on a graphical user interface of a display screen, including graphic controls.

A plurality of program statement blocks may be spliced together to construct a code. The program running state indication system shown in FIG. 1 includes a plurality of program statement blocks, such as a loop-start program statement block 101, an IF-start program statement block 102, and the like.

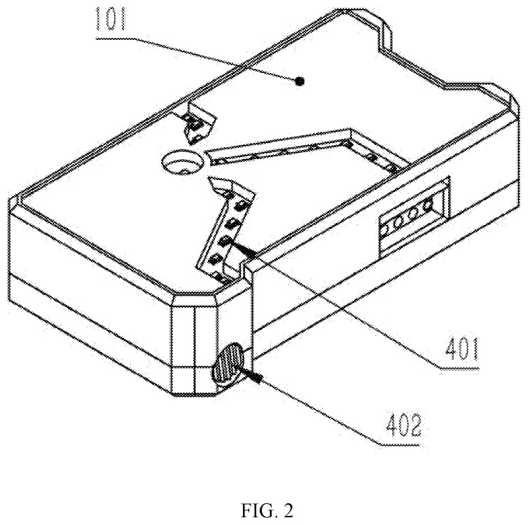

Taking the loop-start program statement block 101 shown in FIG. 2 as an example, the block is provided with an indicator bar configured to indicate a program running state, and the indicator bar includes a plurality of light-emitting units 401 that may be independently controlled.

The light-emitting unit may be implemented by one or more LEDs, screen pixels, miniature bulbs, laser emitters, and the like. Taking LEDs as an example, a single LED or a plurality of LEDs connected in series or parallel form one light-emitting unit. One indicator bar includes a plurality of such light-emitting units. By lighting and extinguishing the light-emitting units, the indicator bar is capable of generating dynamic lighting effects and indicating corresponding program logic semantics according to variations in color, brightness and patterns.

In the present embodiment, a plurality of program statement blocks are spliced to form a program running indicator board configured to represent a designated program module. The above designated program module is defined by the spliced program statement blocks, and the designated program module may be a program composed of any number of lines and any type of code. The designated program module may be a complete program, or a subprogram of a complete program, or an incomplete program. Program semantics may be correct or erroneous. When the program is incomplete or has semantic errors, if an error alarm function is activated, the system is capable of indicating an error state by lighting up or animating some indicator bars or an individual light-emitting unit.

For example, program semantics represented by the designated program module shown in FIG. 1 are as follows:
Loop start
If start(x>1024)
f(1234+x)
Motor rotation (true)
If end
Loop end

A corresponding C language program is as follows:
while(true){
if(x>1024){
f(1234+x);
motorRotate(true);
}
}

The above program running indicator board is a set of spliced program statement blocks, including indicator bars.

Indicator bars in the program running indicator board are mated to form a light-emitting indicator running light strip. As illustrated in FIG. 1, a first indicator bar 3031, a second indicator bar 3032, and a third indicator bar 3033 are mated with each other to form a light-emitting indicator running light strip configured to indicate program running flow control and branch selection. For another example, as illustrated in FIG. 1, a fourth indicator bar 3041, a fifth indicator bar 3042, and a sixth indicator bar 3043 are mated with each other to form a light-emitting indicator running light strip configured to indicate information such as a program expression calculation sequence, an operator precedence, a calculated intermediate quantity, and a calculation result.

The light-emitting indicator running light strip is configured to represent a program running state of the designated program module, when the designated program module is executed, light-emitting units of the light-emitting indicator running light strip are lit sequentially in a running direction of the designated program module, and when the designated program module runs to any program statement, the light-emitting units of the program statement block corresponding to the program statement are lit.

The running direction of the designated program module includes sequential execution and jump from one program line to another program line, and for example, the program in FIG. 1 jumps from a left branch of the IF-start program statement block 102 to an IF-end program statement block 105; or the IF-start program statement block 102 is sequentially executed to a subroutine call program statement block 103 from a right branch; the running direction of the designated program module further includes a direction of data transmission during expression calculation, and for example, an expression formed by x>1234 formed by a first variable program statement block 2011, a comparison operator program statement block 202, and a first constant program statement block 203 as shown in FIG. 1 is: x>1234, where a value of a variable x is transferred from left to right to a comparison operator, a value of a constant 1234 is transferred from right to left to the comparison operator, values of the variable and the constant are compared in the comparison operator, and then a comparison result true or false is obtained; and then this Boolean operation result is transferred from right to left to the IF-start program statement block 102 at the beginning of line, serving as a basis for the program flow control from the left branch if false or the right branch if true.

For example, after the program in FIG. 1 finishes executing a program statement for controlling motor rotation represented by a motor rotation program statement block 104, the program is about to proceed to the right branch of the IF-end program statement block 105. Therefore, lights on the light-emitting indicator running light strip collectively formed by the first indicator bar 3031 and the second indicator bar 3032 are sequentially lit and extinguished from top to bottom, a top-to-bottom flowing light effect is presented, and the light effect is used to analogize the flow of program statements during execution so as to present a user with a current position and direction of program running. When the program runs to the IF-end program statement block 105, the light-emitting unit on the second indicator bar 3032 on the IF-end program statement block 105 is lit, indicating that the program has run to this line of code.

Lighting patterns of the above light-emitting indicator running light strip corresponding to different program running states are different.

For example, the IF-end program statement block 105 has two entry branches, i.e., an upper left branch and an upper right branch of a Y-shape, and one exit branch, i.e., a lower branch of the Y-shape, such that when the program runs from the right branch of the IF-end program statement block 105 to the IF-end program statement block 105, the light-emitting indicator running light strip on the right branch of the IF-end program statement block 105 is lit sequentially from top to bottom; and when the program runs from a left branch of the IF-end program statement block 105 to the IF-end program statement block 105, the light-emitting indicator running light strip on the left branch of the IF-end program statement block 105 is lit sequentially from top to bottom.

In the present embodiment, program statement blocks in the program running indicator board are in one-to-one correspondence with program statements in the designated program module.

For example, the IF-start program statement block 102 in FIG. 1 provides an inverted Y-shaped indicator bar in the program running indicator board, the indicator bar is configured to indicate program running branches and represents program semantics of a branch statement at a starting position in the designated program module; and when the program runs to a branch determination program statement represented by the IF-start program statement block 102, the light-emitting units on the inverted Y-shaped indicator bar on the IF-start program statement block 102 in the program running indicator board are lit correspondingly, and when the program runs to the right branch of the IF-start program statement block 102, the light-emitting indicator running light strip on a right side of the inverted Y-shaped indicator bar of the program running indicator board also is lit sequentially from top to bottom.

During program running, a program statement block corresponding to a previously executed program statement is referred to as a preceding program statement block, a program statement block corresponding to a currently executed program statement is referred to as a current program statement block, and a program statement block corresponding to a next program statement to be executed is referred to as a subsequent program statement block.

For example, as shown in FIG. 1, when the program runs to the IF-start program statement block 102 after executing the loop-start program statement block 101, is about to leave the IF-start program statement block 102 from the right branch of the IF-start program statement block 102, and is about to execute the subroutine call program statement block 103 in the next line, the loop-start program statement block 101 is referred to as the preceding program statement block, the IF-start program statement block 102 is referred to as the current program statement block, and the subroutine call program statement block 103 is referred to as the subsequent program statement block.

When the program runs to a program statement corresponding to any program statement block, the following steps are included:
a program running environment sends a light control instruction to a corresponding program statement block, the light-emitting units of an entry indicator bar of the current program statement block that is mated with the preceding program statement block are controlled to be lit sequentially in a direction from the preceding program statement block to the current program statement block, while brightness of remaining entry indicator bars of the current program statement block remains unchanged;
the program running environment performs calculation or operation of a program statement corresponding to the current program statement block; and
the program running environment sends a light control instruction to a corresponding program statement block, the light-emitting units of the exit indicator bar of the current program statement block that is mated with the subsequent program statement block are controlled to are lit sequentially in a direction from the current program statement block to the subsequent program statement block, while brightness of remaining exit indicator bars of the current program statement block remains unchanged.

For example, when the program in FIG. 1 starts executing a program statement corresponding to the IF-start program statement block 102 after just executing a program statement corresponding to the loop-start program statement block 101, the program running environment sends a light control instruction to the IF-start program statement block 102 to control an entry indicator bar thereof that is mated with the preceding program statement block, i.e., the indicator bar at a middle above the IF-start program statement block 102 is lit sequentially from top to bottom, indicating that the program enters the IF-start program statement block for calculation;
in this case, the program running environment performs calculation of the program statement corresponding to the current program statement block, i.e., determining whether a conditional branch corresponding to the IF-start program statement block should be the left branch or the right branch; and in FIG. 1, the determining means calculating whether the expression x>1234 on the right side holds true, if a calculation result of the expression is true, the right branch of the IF-start program statement block 102 is executed, and if the calculation result of the expression is false, the left branch of the IF-start program statement block 102 is executed; and
assuming that the calculation result indicates that the program proceeds along the right branch of the IF-start program statement block 102, i.e., the next program statement to be executed is the subroutine call program statement block 103, the program running environment sends a light control instruction to the IF-start program statement block 102 to control the exit indicator bar that is mated with the subsequent program statement block, i.e., the indicator bar at a lower right of the IF-start program statement block 102 is lit sequentially from top to bottom, while the brightness of the remaining exit indicator bar (i.e., the lower left indicator bar) remains unchanged.

In an optional embodiment, the program running state includes a program flow control state, a program expression calculation state, and the like.

The program flow control state includes at least one of a sequential program running state, a loop state, a branch state, a jump state, a wait state, and a subroutine call state, and in the present embodiment, the light-emitting indicator running light strip is lit according to a lighting pattern corresponding to the program flow control state when the program running indicator board works.

Taking the loop state as an example, the loop-start program statement block 101 in FIG. 1 represents program logic semantics of a starting point of a program loop, when a loop-end program statement block 106 in FIG. 1 is used together, program semantics of the program loop may be formed, indicating that the program cyclically executes program statements between the loop-start program statement block 101 and the loop-end program statement block 106. When the program runs to a program represented by the loop-end program statement block 106, the program flow control state is the loop state, and the program is about to loop back to a loop start position, i.e., a program position represented by the loop-start program statement block 101.

In this case, the light-emitting indicator running light strip including the third indicator bar 3033 is lit sequentially in a program running direction, and for example, the light-emitting units arranged below the upright U-shaped third indicator bar 3033 on the loop-end program statement block 106 are sequentially lit clockwise and then sequentially extinguished, while the light-emitting units arranged below the inverted U-shaped indicator bar on the loop-start program statement block 101 are sequentially lit clockwise and then sequentially extinguished; and this lighting pattern of the light-emitting indicator running light strip results in that the program running direction changes from an original top-to-bottom running direction to loop back to the loop-start program statement block 101 located above, and then the program continues to execute sequentially downward from the loop-start program statement block 101.

Taking the sequential running state as an example, as shown in FIG. 1, the program is sequentially executed from the subroutine call program statement block 103 to the motor rotation program statement block 104, and the program flow control state is the sequential running state. The light-emitting indicator running light strip including the indicator bars of the subroutine call program statement block 103 and the motor rotation program statement block 104 is lit sequentially from top to bottom and then is sequentially extinguished, indicating that the program is running sequentially downward. When the program runs to the subroutine call program statement block 103, part of the light-emitting units of the light-emitting indicator running light strip on the subroutine call program statement block 103 are lit, indicating that the program currently has run to this line of code; and when the program runs to the motor rotation program statement block 104, part of the light-emitting units of the light-emitting indicator running light strip on the motor rotation program statement block 104 are lit, indicating that the program currently has run to this line of code.

Taking the branch state as an example, as shown in FIG. 1, the IF-start program statement block 102 and the IF-end program statement block 105 respectively constitute a start point and end point of branch; at a program position represented by the IF-start program statement block 102, the program calculates a result according to an expression spliced to the right of the IF-start program statement block 102, and then the program selects to execute the left branch, i.e., directly jumping to the IF-end program statement block 105, or executing the right branch, i.e., sequentially running to the subroutine call program statement block 103, the motor rotation program statement block 104, and the IF-end program statement block 105. When the program flow control state is the branch state, if the program executes the left branch, the indicator bar on a left half of a branch shape in the light-emitting indicator running light strip is lit sequentially from top to bottom, indicating that the program executes the left branch; and if the program executes the right branch, the indicator bar on a right half of the branch shape in the light-emitting indicator running light strip is lit sequentially from top to bottom, indicating that the program executes the right branch.

Taking the jump state as an example, as shown in FIG. 1, when the loop-end program statement block 106 loops back to the loop-start program statement block 101, the program undergoes an actual jump from back to front. During the jump, the program flow control state is the jump state, a second projection lamp 3012 and a first projection lamp 3011 are lit sequentially or simultaneously or either one of them is lit, indicating that the program has jumped from the loop-end program statement block 106 to the loop-start program statement block 101.

Taking the wait state as an example, when the program runs to a wait program statement block, the light-emitting indicator running light strip in the shape of a progress bar on the wait program statement block is gradually lit from one side of the progress bar to the other side of the progress bar, indicating that the program is waiting at this program block. The progress bar may be in the shape of a long strip, a ring, a polyline, or the like.

Taking the subroutine call state as an example, regarding the subroutine call program statement block 103 in FIG. 1, when a target subroutine, i.e., subroutine “f( )”, is being called and executed, the light-emitting indicator running light strip disposed above or around a subroutine identifier (i.e., “f( )”) is lit according to a certain pattern. For example, the light-emitting indicator running light strip surrounding the subroutine identifier is lit and extinguished in a rotating manner; or the light-emitting indicator running light strip gradually brightens and then gradually dims as a whole; or the light-emitting indicator running light strip flashes as a whole.

In an optional embodiment, the program expression calculation state includes a value of a variable or constant, a value of intermediate data of expression calculation, a data type, an expression operator precedence, an order of calculation of each part of the expression, or the like; the indicator bar includes a Boolean data indicator bar and/or a numeric data indicator bar, the Boolean data indicator bar and/or the numeric data indicator bar are respectively disposed in a designated statement block in the program statement block, and when the designated program module performs program expression calculation, the Boolean data indicator bar and/or the numeric data indicator bar are lit according to a lighting pattern corresponding to the program expression calculation state.

Referring to FIG. 1, program semantics of a conditional branch are jointly formed by the IF-start program statement block 102 and the IF-end program statement block 105. A conditional expression for the conditional branch is spliced to the right of the IF-start program statement block 102. The expression is x>1234, and is specifically composed of the first variable program statement block 2011, the comparison operator program statement block 202, and the first constant program statement block 203. Indicator bars for indicating Boolean data transfer, i.e., the above Boolean data indicator bars, are disposed above the designated statement blocks in the expression, such as the first variable program statement block 2011, the comparison operator program statement block 202, and the first constant program statement block 203, where the three indicator bars are adjacent to each other and collectively form a light-emitting indicator running light strip, and the light-emitting indicator running light strip is configured to indicate a Boolean data transfer relationship between the program statements represented by the several program statement blocks.

Indicator bars for indicating numeric data transfer, i.e., the above numeric data indicator bars, are disposed below the designated statement blocks in the expression, such as the first variable program statement block 2011, the comparison operator program statement block 202, and the first constant program statement block 203, where the three indicator bars are adjacent to each other and collectively form a light-emitting indicator running light strip, and the light-emitting indicator running light strip is configured to indicate a numeric data transfer relationship between the program statements represented by the several program statement blocks.

In the present embodiment, the Boolean data indicator bar and the numeric data indicator bar are defined as two independent indicator bars, and in other embodiments, the Boolean data indicator bar and the numeric data indicator bar may be set as the same indicator bar, or only one of them may be set, or neither of them may be set.

It should be noted that the Boolean data indicator bar and the numeric data indicator bar are disposed only in designated statement blocks, such as program statement blocks involving data generation, data calculation, data transfer, or data use of corresponding data types. For example, the IF-start program statement block 102 requires a Boolean expression calculation result as a basis for program running of the left branch or right branch, therefore a Boolean data indicator bar is disposed on the IF-start program statement block 102; and the IF-start program statement block 102 cannot receive numeric data, therefore no numeric data indicator bar is disposed on the IF-start program statement block 102. The first variable program statement block 2011 represents a numeric variable x, therefore a numeric data indicator bar is provided on the first variable program statement block; and the first variable program statement block 2011 may constitute a part of an expression whose return value is Boolean data in the expression, and has the function of transferring Boolean data, therefore a Boolean data indicator bar is provided.

For example, when the conditional expression is satisfied, i.e., when a determination result of x>1234 is true, the indicator bar on the IF-start program statement block 102 representing a start point of the conditional branch sequentially activates the light-emitting units on the right branch of the indicator bar from top to bottom in the program running direction, indicating that the program has executed the right branch, and the light-emitting units of the indicator bars on the subsequent program statement blocks on the right branch (i.e., the subroutine call program statement block 103 and the motor rotation program statement block 104) that are adjacent to each other, are also sequentially lit from top to bottom in the program running direction; and when the conditional expression is not satisfied, i.e., when the determination result of x>1234 is false, the indicator bar on the IF-start program statement block 102 representing the start point of the conditional branch sequentially activates the light-emitting units on the left branch of the indicator bar from top to bottom in the program running direction, indicating that the program has executed the left branch; through the left branch of the IF-start program statement block 102, the program directly jumps to the left branch of the IF-end program statement block 105, and the left branch of the indicator bar of the IF-end program statement block 105 sequentially activates the light-emitting units on the left branch from top to bottom in the program running direction.

The indicator bar on the right branch of the IF-start program statement block 102, the indicator bar of the subroutine call program statement block 103, and the indicator bar of the motor rotation program statement block 104 are adjacent to each other, the adjacent indicator bars form a light-emitting indicator running light strip, and the light-emitting indicator running light strip is configured to indicate a program running state transfer relationship between the program statements represented by the program statement blocks, that is, after running to the right branch of the IF-start program statement block 102, the program executes the program statement represented by the subroutine call program statement block 103, and then executes the program statement represented by the motor rotation program statement block 104, where the program running state is transferred between the program statements represented by the above blocks.

The above program statement blocks include conditional branch blocks, and the indicator bar of each of the conditional branch blocks includes at least one program entry indicator bar and at least two program exit indicator bars.

Referring to FIG. 1, the IF-start program statement block 102 is a type of conditional branch block provided with an inverted Y-shaped indicator bar, a program entry indicator bar of the program statement is disposed above the program statement block, and two program exit indicator bars of the program statement are disposed below the program statement block.

In the present embodiment, the numeric data includes integers, floating-point numbers, decimals, fractions, and the like. The Boolean data includes true and false. Data transfer includes a logical process of transferring data represented by a variable or constant to an operator for operation during expression calculation, a logical process of transferring an intermediate value or result of expression calculation, or the like.

For example, for the expression x>1234, the program statements involved in the expression calculation correspond to the first variable program statement block 2011, the comparison operator program statement block 202, and the first constant program statement block 203. Taking the first variable program statement block 2011 as an example, a first Boolean data indicator bar 3021 representing Boolean data transfer is disposed above the first variable program statement block, and a numeric data indicator bar representing numeric data transfer is disposed below the first variable program statement block.

Operating principles of the Boolean data indicator bar and the numeric data indicator bar are described below by taking a process of calculation and data transfer of the expression x>1234 as an example.

First, a current value of a variable x is acquired, the first variable program statement block 2011 presents a value represented by the numeric variable x through the numeric data indicator bar located below the block, and a lamp below the first variable program statement block 2011 is lit with a brightness corresponding to a value of the variable x. Brightness or color of the numeric data indicator bar activated is related to a value or type of transferred data. For example, when transferred data is numeric data, blue represents a positive number and purple represents a negative number; and when the transferred data is Boolean data, red represents false and green represents true. When semantics of the lit indicator bar configured to indicate data transfer is numeric data transfer, the brightness of the indicator bar is positively correlated with a magnitude of the transferred numeric data or an absolute value of the numeric data. For example, when a value of x is 50, light brightness is 50%, and when the value of x is 20, the light brightness is 20%, intuitively reflecting a real-time value of x. In this calculation process, it is assumed that a current value of x is 20.

Second, a value represented by the first constant program statement block 203 is acquired, the first constant program statement block 203 presents a value represented by the numeric constant 1234 through the numeric data indicator bar located below the block, and for example, the constant 1234 has a value of 1234, and the light brightness of 100%. By observing the brightness of the numeric data indicator bar of the first variable program statement block 2011 and the brightness of the numeric data indicator bar of the first constant program statement block 203, a user can intuitively identify a magnitude relationship between the two values.

Third, the comparison operator program statement block 202 that connects the first variable program statement block 2011 and the first constant program statement block 203 is configured to compare the two numeric data and generate Boolean comparison result data. During calculation, a numeric data transfer process is that the first variable program statement block 2011 transfers the numeric data of the value of x to the comparison operator program statement block 202 from left to right, and the light-emitting units on a left half of the indicator bar representing numeric data transfer and located below the comparison operator program statement block 202 are sequentially lit from left to right; and the first constant program statement block 203 transfers the numeric data of a value of the constant 1234 to the comparison operator program statement block 202 from right to left, and the light-emitting units on a right half of the indicator bar representing numeric data transfer and located below the comparison operator program statement block 202 are sequentially lit from right to left.

Fourth, greater-than determination is performed, and when it is determined that a left value is not greater than a right value, a resulting determination result is false. When semantics of the lit indicator bar configured to indicate data transfer is Boolean data transfer, the indicator bar is lit in different colors when transferring true and false. Here, red represents false and green represents true. When Boolean data indicator bar above the comparison operator program statement block 202 is lit in red, it indicates that a Boolean result generated by the greater-than determination is false.

Fifth, the expression calculation result is transferred to the IF-start program statement block 102. A determination result of a greater-than determination program statement represented by the comparison operator program statement block 202 is false, and the Boolean data needs to be transferred to the IF-start program statement block 102, such that the red light-emitting units representing false located on the indicator bars indicating Boolean data transfer on the comparison operator program statement block 202, the first variable program statement block 2011, and the IF-start program statement block 102 are sequentially lit from right to left, reflecting a transfer process of false data.

When any program statement block is connected to other program statement blocks to form an expression, and a potential data transfer path represented by an indicator bar configured to indicate data transfer does not constitute a valid data transfer path, the indicator bar is invisible.

The data transfer path refers to a path from a data-generating program statement to a data-using program statement. For example, in the above process of transferring Boolean data of the calculation result of the expression x>1234 to the IF-start program statement block 102, the Boolean data is generated by the comparison operator program statement block 202 and presented by the Boolean data indicator bar above the comparison operator program statement block 202, and data is transferred to the IF-start program statement block 102 via the first Boolean data indicator bar 3021 above the first variable program statement block 2011, and presented by the Boolean data indicator bar at the upper right of the IF-start program statement block 102. The data transfer path in this case includes the indicator bars indicating Boolean data transfer and located above the comparison operator program statement block 202, the first variable program statement block 2011, and the IF-start program statement block 102.

The potential data transfer path refers to an indicator bar that may serve as part of a data transfer path, such as the first Boolean data indicator bar 3021 and a second Boolean data indicator bar 3022 above the first variable program statement block 2011 and a second variable program statement block 2012. Since the first Boolean data indicator bar 3021 above the first variable program statement block 2011 participates in transferring Boolean data of a calculation result of the expression x>1234, a potential data transfer path thereof constitutes a valid data transfer path, so the first Boolean data indicator bar 3021 is visible.

Since the second Boolean data indicator bar 3022 above the second variable program statement block 2012 does not participate in transferring any Boolean data in an expression 1234+x, a potential data transfer path of the indicator bar does not constitute a valid data transfer path, so the second Boolean data indicator bar 3022 is invisible.

In the program running state indication system shown in FIG. 1, the first indicator bar 3031, the second indicator bar 3032, and the third indicator bar 3033 collectively form a light-emitting indicator running light strip configured to indicate the program flow control state; and the fourth indicator bar 3041, the fifth indicator bar 3042, and the sixth indicator bar 3043 collectively form a light-emitting indicator running light strip configured to indicate the program expression calculation state.

For example, as shown in FIG. 1, program statement blocks that are spliced together to form the light-emitting indicator running light strip configured to indicate the program flow control state include all program statement blocks located at the beginning of line, such as the loop-start program statement block 101, the IF-start program statement block 102, the subroutine call program statement block 103, the motor rotation program statement block 104, the IF-end program statement block 105, and the loop-end program statement block 106. These program statement blocks all include indicator bars that may be spliced together to form a light-emitting indicator running light strip configured to indicate the program flow control state, such as the first indicator bar 3031, the second indicator bar 3032, the third indicator bar 3033, or the like.

In an optional embodiment, the above program statement blocks are physical code blocks, the light-emitting indicator running light strip formed after splicing is configured to indicate the program flow control state, and in this case, in the spliced program running indicator board, the indicator bar of each of the program statement blocks includes at least one entry indicator bar and at least one exit indicator bar. For example, the Y-shaped indicator bar disposed on the IF-end program statement block 105 includes an entry indicator bar at the upper left, an entry indicator bar at the upper right, and an exit indicator bar located below. One end of the entry indicator bar extends to a mating end face of the program statement block, the other end of the entry indicator bar is connected to one end of the exit indicator bar, and the other end of the exit indicator bar extends to a mating end face of the program statement block.

Specifically, one end of each of the two entry indicator bars and one end of the exit indicator bar are connected at a center point of the Y-shape, and the other end of each of the indicator bars extends to a mating end face of the program statement block respectively. For example, the entry indicator bar at the upper right extends to a mating end face of an interface of the program statement block directly connected above, and is mated with the motor rotation program statement block 104 with reference to FIG. 1; the entry indicator bar at the upper left extends to a mating end face of a logical interface of the program statement block indirectly connected above, and an extension line of this indicator bar is mated with the IF-start program statement block 102 in logical semantics; and the exit indicator bar located below extends to a mating end face of an interface of the program statement block directly connected below, and is mated with the loop-end program statement block 106, as shown in FIG. 1. When each of the above program statement blocks is a graphic control on a graphical user interface of a display screen, the mating end face is a graphic edge where two program statement block graphics are butt-joined with each other; and when the above program statement block is a physical code block, the mating end face is an outer surface where the physical code blocks engage with each other.

When the above program statement blocks are spliced together, the entry indicator bars and the exit indicator bars between the program statement blocks are mated with each other to form the above light-emitting indicator running light strip. For example, as shown in FIG. 1, the entry indicator bar at the upper right of the IF-end program statement block 105 is mated with the first indicator bar 3031 as an exit indicator bar below the motor rotation program statement block 104; the entry indicator bar at the upper left of the IF-end program statement block 105 is logically mated with the exit indicator bar at the lower left of the IF-start program statement block 102, where the remote mating means that extension lines of the two mated indicator bars are directly connected, presenting logical semantics of mating; and the exit indicator bar below the IF-end program statement block 105 is mated with the third indicator bar 3033 as an entry indicator bar above the loop-end program statement block 106. These indicator bars are mated to form a light-emitting indicator running light strip.

In an optional embodiment, one or more program statement blocks constitute one line of program statement unit, each line of program statement unit represents one line of code in the designated program module, and the program running indicator board is composed of a plurality of lines of the program statement units. Referring to FIG. 1, a first line of the program includes only one loop-start program statement block 101, the program statement block constitutes one line of program statement unit, representing a first line of code “loop start” in the designated program module; a second line of the program includes one IF-start program statement block 102, one first variable program statement block 2011, one comparison operator program statement block 202, and one first constant program statement block 203, and the four program statement blocks constitute one line of program statement unit, representing a second line of code “IF start (x>1234)” in the designated program module; a third line of the program includes one subroutine call program statement block 103, one second constant program statement block, one plus operator program statement block, and one second variable program statement block 2012, and the four program statement blocks constitute one line of program statement unit, representing a third line of code “f(1234+x)” in the designated program module; a fourth line of the program includes one motor rotation program statement block 104 and one Boolean constant program statement block, and the two program statement blocks constitute one line of program statement unit, representing a fourth line of code “motor rotation (true)” in the designated program module; a fifth line of the program includes only one IF-end program statement block 105, and the program statement block constitutes one line of program statement unit, representing a first line of code “IF end” in the designated program module; and a sixth line of the program includes only one loop-end program statement block 106, and the program statement block constitutes one line of program statement unit, representing a first line of code “loop end” in the designated program module.

In the present embodiment, the above six lines of program statement unit collectively constitute the program running indicator board, and the corresponding light-emitting indicator running light strip includes a first light-emitting light strip configured to represent the program flow control state and a second light-emitting light strip configured to represent the program expression calculation state. The first indicator bar 3031, the second indicator bar 3032, and the third indicator bar 3033 collectively form a light-emitting indicator running light strip configured to indicate the program flow control state and referred to as the first light-emitting light strip; and the fourth indicator bar 3041, the fifth indicator bar 3042, and the sixth indicator bar 3043 collectively form a light-emitting indicator running light strip configured to indicate the program expression calculation state and referred to as the second light-emitting light strip.

The first light-emitting light strip extends from the program statement unit in the first line to the program statement unit in the last line, and for example, the light-emitting indicator running light strip located on the far left in FIG. 1, penetrating through all program statement blocks at the beginning of lines, is collectively formed by part of indicator bars on each program statement block at the beginning of line, such as the first indicator bar 3031, the second indicator bar 3032, and the third indicator bar 3033.

A second light-emitting indicator running light strip is horizontally distributed along the program statement unit in a designated line, and for example, the numeric data indicator bar distributed transversely below the expression f(1234+x) in the third line of the program in FIG. 1 is collectively formed by the fourth indicator bar 3041, the fifth indicator bar 3042, and the sixth indicator bar 3043.

In an optional embodiment, the program statement unit in a designated line is formed by splicing a plurality of program statement blocks, and for example, the program statement unit of the third line is collectively formed by the subroutine call program statement block 103, the second constant program statement block, the plus operator program statement block, and the second variable program statement block 2012.

In an optional embodiment, the program statement blocks may be identical and/or different in types, and the types of the program statement blocks include at least two of a flow control type, a data structure type, an input/output type, and an operator type, where program statement blocks of the flow control type include the loop-start program statement block 101, the loop-end program statement block 106, the IF-start program statement block 102, an else program statement block, the IF-end program statement block 105, and the like; program statement blocks of the data structure type include the variable program statement block, the constant program statement block, the Boolean constant program statement block, and the like; program statement blocks of the input/output type include the motor rotation program statement block 104, a motor stop program statement block, a sensor read program statement block, and the like; and program statement blocks of the operator type include the comparison operator program statement block 202, the plus operator program statement block, and the like.

Referring to FIG. 1, the program running indicator board includes the loop-start program statement block 101 of the flow control type, the variable program statement block of the data structure type, the motor rotation program statement block 104 of the input/output type, and the plus operator program statement block of the operator type, and the like.

In an optional embodiment, the program running indicator board may be configured to represent jump semantics, and the corresponding spliced program statement blocks may be referred to as jump semantic program statement blocks. Referring to FIG. 1, for the IF-start program statement block 102 and the IF-end program statement block 105, if the program follows the left branch of the IF-start program statement block 102, the program jumps directly from the left branch of the IF-start program statement block 102 in the second line to the left branch of the IF-end program statement block 105 in the fifth line. For another example, for the loop-end program statement block 106 and the loop-start program statement block 101, when the loop-end program statement block 106 in the sixth line runs to the leftmost branch and after the program reaches the exit indicator bar, the program jumps back to the leftmost branch of the loop-start program statement block 101 in the first line.

In the present embodiment, the jump semantic program statement block is provided with a spotlight or a projection lamp, and a lighting direction of the spotlight or the projection lamp is the same as a program jump direction.

For example, the loop-end program statement block 106 represents that when the program runs to a loop-end program statement, the program jumps back to a loop-start program statement represented by the loop-start program statement block 101. Therefore, a spotlight or the second projection lamp 3012 and the first projection lamp 3011 are respectively disposed on each of the loop-end program statement block 106 as a jump start point and the loop-start program statement block 101 as a jump end point, where the spotlight or the second projection lamp 3012 is lit from the jump start point to the jump end point, and the spotlight or the first projection lamp 3011 is lit from the jump end point to the jump start point.

There may exist a plurality of jump semantic program statement blocks in the system, and spotlights or projection lamps may be disposed only on part of the program statement blocks. For example, spotlights or projection lamps may be disposed on both of the loop-start program statement block 101 and the loop-end program statement block 106, or a spotlight or projection lamp may be disposed on only one of the two program statement blocks.

In an optional embodiment, the system further includes an input device, such as a ranging sensor, a photosensitive sensor, and the like. There are program statement blocks corresponding to the input device in the system, such as a program statement block “Read ranging sensor reading” corresponding to the ranging sensor, and a program statement block “Read photosensitive sensor reading”, and the like. In the present embodiment, the light-emitting units on the program statement block corresponding to the input device are lit according to an input state of the input device; and when the input state of the input device varies, the light-emitting units on the program statement block corresponding to the input device are lit in different colors, brightness or patterns.

For example, during program running, when the program runs to a program statement corresponding to the program statement block of “Read ranging sensor reading”, the ranging sensor obtains sensor information and transfers the reading or display content corresponding to the reading to the program statement block of “Read ranging sensor reading”, and the program statement block of “Read ranging sensor reading” illuminates the light-emitting units provided thereon according to the reading or the display content corresponding to the reading. For example, the larger reading indicates higher brightness of the light-emitting units; or when the reading is greater than a certain threshold, the color of the light-emitting units is green, and when the reading is less than the certain threshold, the color of the light-emitting units is orange; or the reading is directly displayed in a digital tube pattern; or when the reading is larger, more light-emitting units are lit, and different patterns are presented based on a magnitude of the reading.

In an optional embodiment, based on the above, the program statement blocks are displayed on a graphical user interface of a display screen, the program statement blocks are graphic controls on the graphical user interface, the indicator bars are strip-shaped patterns, and the light-emitting units are graphic elements or screen pixels in the strip-shaped patterns. The user can drag and drop the program statement blocks on the graphical user interface using a mouse or touch screen to splice them together to form the above program running indicator board, i.e., to splice the program statement blocks to construct a program.

In an optional embodiment, based on the above, the program statement blocks are physical code blocks, the physical code blocks are provided with electronic interfaces, and the physical code blocks are connected to each other via the electronic interfaces; and the indicator bars are plastic parts and screen-printed patterns, the light-emitting units are lamp beads or small screens embedded in the program statement blocks, the lamp beads may be LEDs, and the small screens may be OLED screens, e-ink screens, or TFT screens. The user can construct a program by connecting the electronic interfaces of the physical code blocks.

The present disclosure further provides a physical code block, the physical code block includes a building block body, and the building block body is the program statement block described in the foregoing embodiments.

The embodiments mentioned above are merely preferred implementations of the present disclosure, and are specifically described in details, but may not be interpreted as limiting the scope of the patent for the present disclosure as a result. It should be noted that for those of ordinary skill in the art, they may also make several transformations and improvements on the premise of not deviating from the conception of the present disclosure, and these transformations and improvements shall fall within the scope of protection of the present disclosure. The scope of protection of the present patent for disclosure shall be governed by the appended claims.

What is claimed is:

1. A program running state indication system, comprising a plurality of program statement blocks, wherein each of the program statement blocks is provided with an indicator bar comprising a plurality of light-emitting units, the plurality of program statement blocks are spliced to form a program running indicator board configured to represent a designated program module, and the indicator bars in the program running indicator board are mated to form a light-emitting indicator running light strip; the light-emitting indicator running light strip is configured to represent a program running state of the designated program module, when the designated program module is executed, the light-emitting units of the light-emitting indicator running light strip are lit sequentially in a running direction of the designated program module, and when the designated program module runs to any program statement, the light-emitting units of the program statement block corresponding to the program statement are lit, wherein lighting patterns of the light-emitting indicator running light strip corresponding to different program running states are different, and the program statement blocks in the program running indicator board are in one-to-one correspondence with program statements in the designated program module;
the light-emitting indicator running light strip formed after splicing is configured to indicate a program flow control state, the indicator bar of each of the program statement blocks comprises at least one entry indicator bar and at least one exit indicator bar, one end of the entry indicator bar extends to a mating end face of the program statement block, the other end of the entry indicator bar is connected to one end of the exit indicator bar, and the other end of the exit indicator bar extends to a mating end face of the program statement block;
when the program statement blocks are spliced together, the entry indicator bars and the exit indicator bars between the program statement blocks are mated with each other to form the light-emitting indicator running light strip;
at least one program statement block in the program running state indication system comprises at least two exit indicator bars;
during program running, a program statement block corresponding to a previously executed program statement is referred to as a preceding program statement block, a program statement block corresponding to a currently executed program statement is referred to as a current program statement block, and a program statement block corresponding to a next program statement to be executed is referred to as a subsequent program statement block;
when the program runs to a program statement corresponding to any program statement block, the following steps are comprised:
the light-emitting units of the entry indicator bar of the current program statement block that is mated with the preceding program statement block are lit sequentially in a direction from the preceding program statement block to the current program statement block, while brightness of remaining entry indicator bars of the current program statement block remains unchanged;
calculation or operation of a program statement corresponding to the current program statement block is performed; and
the light-emitting units of the exit indicator bar of the current program statement block that is mated with the subsequent program statement block are lit sequentially in a direction from the current program statement block to the subsequent program statement block, while brightness of remaining exit indicator bars of the current program statement block remains unchanged.

2. The program running state indication system according to claim 1, wherein the program running state comprises a program flow control state, and the program flow control state comprises at least one of a sequential program running state, a loop state, a branch state, a jump state, a wait state, and a subroutine call state, and the light-emitting indicator running light strip is lit according to a lighting pattern corresponding to the program flow control state when the program running indicator board works.

3. The program running state indication system according to claim 1, wherein the program running state comprises a program expression calculation state, the indicator bar comprises a Boolean data indicator bar and/or a numeric data indicator bar, the Boolean data indicator bar and/or the numeric data indicator bar are respectively disposed in a designated statement block in the program statement block, and when the designated program module performs program expression calculation, the Boolean data indicator bar and/or the numeric data indicator bar are lit according to a lighting pattern corresponding to the program expression calculation state.

4. The program running state indication system according to claim 1, wherein one or more program statement blocks constitute one line of program statement unit, the program statement unit in each line stores one line of code in the designated program module, and the program running indicator board is composed of a plurality of lines of the program statement units; and
the light-emitting indicator running light strip comprises a first light-emitting light strip configured to represent the program flow control state and a second light-emitting light strip configured to represent the program expression calculation state, the first light-emitting light strip extends from the program statement unit in a first line to the program statement unit a last line, the second light-emitting indicator running light strip is horizontally distributed along the program statement unit in a designated line, and the program statement unit in the designated line is formed by splicing a plurality of the program statement blocks.

5. The program running state indication system according to claim 1, wherein the program statement blocks are identical and/or different in types, and the types of the program statement blocks comprise at least two of a flow control type, a data structure type, an input/output type, and an operator type.

6. The program running state indication system according to claim 1, wherein the program statement block comprises a jump semantic program statement block, the jump semantic program statement block is provided with a spotlight or a projection lamp, and a lighting direction of the spotlight or the projection lamp is the same as a jump direction of the designated program module.

7. The program running state indication system according to claim 3, wherein the Boolean data indicator bar is lit in different colors when values of the Boolean data indicator bar calculated in the program expression calculation state are Boolean true and Boolean false; and the numeric data indicator bar is lit with a higher brightness when an absolute value of a value of the numeric data indicator bar calculated in the program expression calculation state is larger.

8. The program running state indication system according to claim 1, further comprising an input device, wherein the light-emitting units on the program statement block corresponding to the input device are lit according to an input state of the input device; and when the input state of the input device varies, the light-emitting units on the program statement block corresponding to the input device are lit in different colors, brightness or patterns.

9. The program running state indication system according to claim 1, wherein the program statement blocks are physical code blocks, the physical code blocks are provided with electronic interfaces, and the physical code blocks are connected to each other via the electronic interfaces.

10. A physical code block, comprising a building block body, wherein the building block body is the program statement block in the program running state indication system according to claim 9.
